(19) United States
(12) Patent Application Publication
(10) Pub. No.: US 2016/0162116 A1
(43) Pub. Date: Jun. 9, 2016

(54) DISPLAY DEVICE

(71) Applicant: SHARP KABUSHIKI KAISHA, Osaka (JP)

(72) Inventors: Yoichi KUGE, Osaka (JP); Noriyuki HOSHIAI, Osaka (JP)

(73) Assignee: Sharp Kabushiki Kaisha, Osaka (JP)

(21) Appl. No.: 14/903,246

(22) PCT Filed: Jul. 4, 2014
(86) PCT No.: PCT/JP2014/067937

§ 371 Date: Jan. 6, 2016

(30) Foreign Application Priority Data
Jul. 11, 2013 (JP) 2013-145673

(51) Int. Cl. G06F 3/041; G06F 3/0488

(52) U.S. Cl. CPC G06F 3/0418; G06F 3/0412; G06F 3/0488

(57) ABSTRACT

A display device with a lock function includes a touch panel; a display panel control unit that drives the display panel; a touch panel control unit that controls the touch panel; a lock setting unit that, at a prescribed timing, makes the display panel control unit display a lock screen showing an unlock image and activates the lock function; and an unlock unit that deactivates the lock function when a specific touch operation with respect to the unlock image is received; a coordinate setting unit that sets, when the lock function is deactivated, coordinate data that represents the coordinate range of the touch panel in accordance with the specific touch operation and the display location of the unlock image; and a correction unit that, after the lock function is deactivated, corrects the input location of an touch operation performed on the touch panel in accordance with the coordinate data.

### TECHNICAL FIELD

The present invention relates to a display device. In particular, it relates to a technology that corrects the input location of a touch operation on a display device equipped with a touch panel.

### BACKGROUND ART

Among mobile phone devices or the like equipped with a touch panel, there are devices that have a lock function for preventing accidental operation. When the lock function is active, the display screen shows a lock screen that indicates that the screen is locked. Performing a prescribed touch panel operation on the lock screen unlocks the screen and enables the user to use applications installed in the device. Japanese Patent Application Laid-Open Publication No. 2013-93699 discloses a mobile phone device that displays on the lock screen notifications about received phone calls or text/email and a lock object for unlocking. When an operation by the user on the lock object satisfies a prescribed condition, the mobile phone device unlocks the screen and displays additional information such as phone numbers of received phone calls and text/email messages.

Depending on usage environment, the accuracy of a display device equipped with a touch panel in detecting input location may be lowered, and a calibration for correcting input location is sometimes performed. As disclosed by Japanese Patent Application Laid-Open Publication No. 2011-164742, a calibration can be performed by a method in which the display device displays an adjustment screen showing a cross-shaped mark or the like for adjusting the coordinates of the touch panel and adjusts the coordinates of the touch panel based on the results of the touching of the cross-shaped mark by the user, for example.

### SUMMARY OF THE INVENTION

When calibrating the touch panel in a mobile phone device or the like equipped with a lock function as described in Japanese Patent Application Laid-Open Publication No. 2013-93699, the adjustment screen like that in Japanese Patent Application Laid-Open Publication No. 2011-164742 needs to be provided separately from a lock screen. This requires the user to perform an additional touch operation, in addition to the unlocking operation.

The present invention provides a technology that corrects input location on the touch panel in a display device that has a touch panel and a lock function for preventing accidental input operation without separately providing an adjustment screen that adjusts the coordinates of a touch panel.

A display device according to invention 1 is a display device, including: a display unit; a touch panel; a lock setting unit that, at a prescribed timing, displays a prescribed image on a display region of the display unit and activates a lock function, the lock function making invalid any touch operation on the touch panel other than a specific touch operation with respect to the prescribed image; an unlock unit that, when a touch operation is performed on the touch panel after the prescribed image is displayed, deactivates the lock function when the unlock unit determines that the touch operation is the specific touch operation based upon a plurality of obtained input locations due to the touch operation and a display location of the prescribed image on the display region; a coordinate setting unit that, when the unlock unit determines that the specific touch operation is performed, sets coordinate data representing a coordinate range of the touch panel based upon the plurality of input locations and the display location of the prescribed image; and a correction unit that corrects an input location of a touch operation that is performed after the unlock unit deactivates the lock function on the touch panel in accordance with the coordinate data set by the coordinate setting unit.

Invention 2 is invention 1, wherein the display region has a rectangular shape, wherein the prescribed image includes: a first line segment image that is parallel to one side of the rectangular shape; and a second line segment image that is parallel to a side of the rectangular shape perpendicular to the one side of the rectangular shape, wherein the specific touch operation is an operation that traces the first line segment image and the second line segment image, wherein the unlock unit determines that the specific touch operation has been performed and deactivates the lock function when the plurality of input locations on the touch panel with respect to at least one of the first line segment image and the second line segment image is within a prescribed range that is perpendicular to the respective line segment images, and wherein, when the lock function is deactivated, the lock setting unit sets the coordinate range.

Invention 3 is invention 1 or invention 2, wherein, when a distance between base coordinates that define the coordinate range, set based upon the plurality of input locations and the display location of the prescribed image, and reference base coordinates that define a coordinate range of the touch panel that is set in advance, is greater than or equal to a threshold value, the coordinate setting unit sets the reference base coordinates as the coordinate data.

Invention 4, is invention 1 or invention 2, wherein, when a distance between base coordinates that define the coordinate range, set based upon the plurality of input locations and the display location of the prescribed image, and reference base coordinates that define a coordinate range of the touch panel that is set in advance, is greater than or equal to a threshold value, the coordinate setting unit sets, as the coordinate data, upper limit coordinates, which are between the base coordinates and the reference base coordinates and for which a distance between the upper limit coordinates and the reference base coordinate is less than the threshold value.

Invention 5 is any one of inventions 1 to 4, wherein the prescribed timing is at least one of a timing at which the self device is turned ON and a timing at which a state in which no touch operation is performed has continued for a certain length of time after the lock function has been deactivated.

According to a configuration of the present invention, a display device that includes a touch panel and a lock function for preventing accidental operation can correct input location on the touch panel without separately providing an adjustment screen that adjusts the coordinates of the touch panel.

### BRIEF DESCRIPTION OF THE DRAWINGS

FIG. 1 is a block diagram showing a schematic configuration of a display device according to an embodiment.

FIG. 2 is a block diagram showing function blocks of a control unit shown in FIG. 1.

FIG. 3 is a schematic diagram showing an example of an unlock image in the display region of the display panel shown in FIG. 1.

FIG. 4 is a chart showing a flow of operation in the display device according to the embodiment.

FIG. 5 is a diagram describing the display location of the unlock image in the coordinate plane of the display region.

FIG. 6 is a diagram showing input locations in the coordinate plane of the sensing region of the touch panel shown in FIG. 1.

FIG. 7 is a schematic diagram showing an example of an unlock image in Modification Example 2.

### DETAILED DESCRIPTION OF EMBODIMENT

A display device according to one embodiment of the present invention is a display device, including: a display unit; a touch panel; a lock setting unit that, at a prescribed timing, displays a prescribed image on a display region of the display unit and activates a lock function, the lock function making invalid any touch operation on the touch panel other than a specific touch operation with respect to the prescribed image; an unlock unit that, when a touch operation is performed on the touch panel after the prescribed image is displayed, deactivates the lock function when the unlock unit determines that the touch operation is the specific touch operation based upon a plurality of obtained input locations due to the touch operation and a display location of the prescribed image on the display region; a coordinate setting unit that, when the unlock unit determines that the specific touch operation is performed, sets coordinate data representing a coordinate range of the touch panel based upon the plurality of input locations and the display location of the prescribed image; and a correction unit that corrects an input location of a touch operation that is performed after the unlock unit deactivates the lock function on the touch panel in accordance with the coordinate data set by the coordinate setting unit (configuration 1).

According to configuration 1, the lock setting unit displays the prescribed image at the prescribed timing and activates the lock function. Based on the plurality of input locations on the touch panel of a touch operation during the setting of the lock function and the display location of the prescribed image, the unlock unit deactivates the lock function when the touch operation is the specific touch operation with respect to the prescribed image. The coordinate setting unit sets, based on the plurality of input locations and the display location of the prescribed image, coordinate data representing the coordinate range of the touch panel. After the lock function is deactivated, the correction unit corrects the input location of the touch operation performed on the touch panel based on the coordinate data. Thus, without separately providing a calibration screen for adjusting the coordinates of the touch panel, the display device can adjust the coordinate range of the touch panel using the touch operation involved in unlocking the lock function and correct the input location after the lock function is deactivated.

Configuration 2 is configuration 1, wherein the display region has a rectangular shape, wherein the prescribed image includes: a first line segment image that is parallel to one side of the rectangular shape; and a second line segment image that is parallel to a side of the rectangular shape perpendicular to the one side of the rectangular shape, wherein the specific touch operation is an operation that traces the first line segment image and the second line segment image, wherein the unlock unit determines that the specific touch operation has been performed and deactivates the lock function when the plurality of input locations on the touch panel with respect to at least one of the first line segment image and the second line segment image is within a prescribed range that is perpendicular to the respective line segment images, and wherein, when the lock function is deactivated, the lock setting unit sets the coordinate range.

According to configuration 2, the prescribed image includes the first line segment image that is parallel to one side of the display region and the second line image that is parallel to a side of the display region perpendicular to that one side of the display region. When a touch operation tracing the first line segment image and the second line segment image is performed, if the touch operation with respect to at least either of the line segment images falls within the prescribed range that stretches in a direction perpendicular to the respective line segment images, it will be determined that the specific touch operation has been performed, and thus the lock function will be deactivated, and the coordinate range of the touch panel will be set. Each of the line segment images is parallel to one side of the display region. The direction in which the input location with respect to the respective line segment images can shift in location is perpendicular to the respective line segment images. When the prescribed image is a curved or oblique line that is not parallel to one side of the display region, input location with respect to the prescribed image can shift in position in two perpendicular directions in the display region. In this case, whether or not the amount of shift in position in the two directions is within a prescribed range needs to be determined. Thus, setting the prescribed image as a line segment image that is parallel to one side of the display region simplifies the determination of whether or not the specific operation with respect to the first and the second line segment images was performed.

Configuration 3 is configuration 1 or configuration 2, wherein, when a distance between base coordinates that define the coordinate range, set based upon the plurality of input locations and the display location of the prescribed image, and reference base coordinates that define a coordinate range of the touch panel that is set in advance, is greater than or equal to a threshold value, the coordinate setting unit sets the reference base coordinates as the coordinate data.

According to configuration 3, compared to when the base coordinates of the set coordinate range are not limited, the correction amount for input location on the touch panel can be controlled so as not to vary too much between successive settings of the base coordinates.

Configuration 4 is configuration 1 or configuration 2, wherein, when a distance between base coordinates that define the coordinate range, set based upon the plurality of input locations and the display location of the prescribed image, and reference base coordinates that define a coordinate range of the touch panel that is set in advance, is greater than or equal to a threshold value, the coordinate setting unit sets, as the coordinate data, upper limit coordinates, which are between the base coordinates and the reference base coordinates and for which a distance between the upper limit coordinates and the reference base coordinate is less than the threshold value.

According to configuration 4, compared to when the base coordinates of the set coordinate range are not limited, the amount of correction for input location on the touch panel can be controlled so as not to vary too much between successive settings of the base coordinates.

Configuration 5 is any one of configurations 1 to 4, wherein the prescribed timing is at least one of a timing at which the self device is turned ON and a timing at which a state in which no touch operation is performed has continued for a certain length of time after the lock function has been deactivated.

According to configuration 5, the display device can correct the coordinate range of the touch panel either when the display device is turned ON or when a state in which no operation is performed has continued for a given length of time.

An embodiment of the present invention will be described in detail below with reference to the drawings. Portions in the drawings that are the same or similar are assigned the same reference characters and descriptions thereof will not be repeated.

(Configuration)

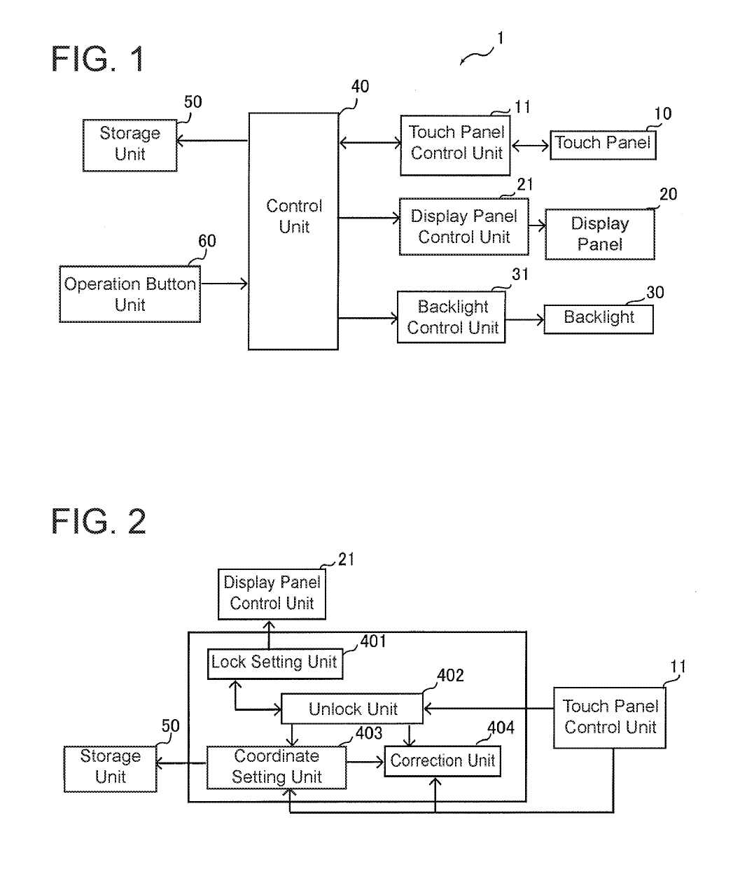

FIG. 1 is a block diagram showing a schematic configuration of a display device according to the present embodiment. The display device 1 is used in a smartphone, a tablet device, or the like, for example. The display device 1 includes a touch panel 10, a touch panel control unit 11, a display panel 20, a display panel control unit 21, a backlight 30, a backlight control unit 31, a control unit 40, a storage unit 50, and an operation button unit 60. Each of these units will be described below.

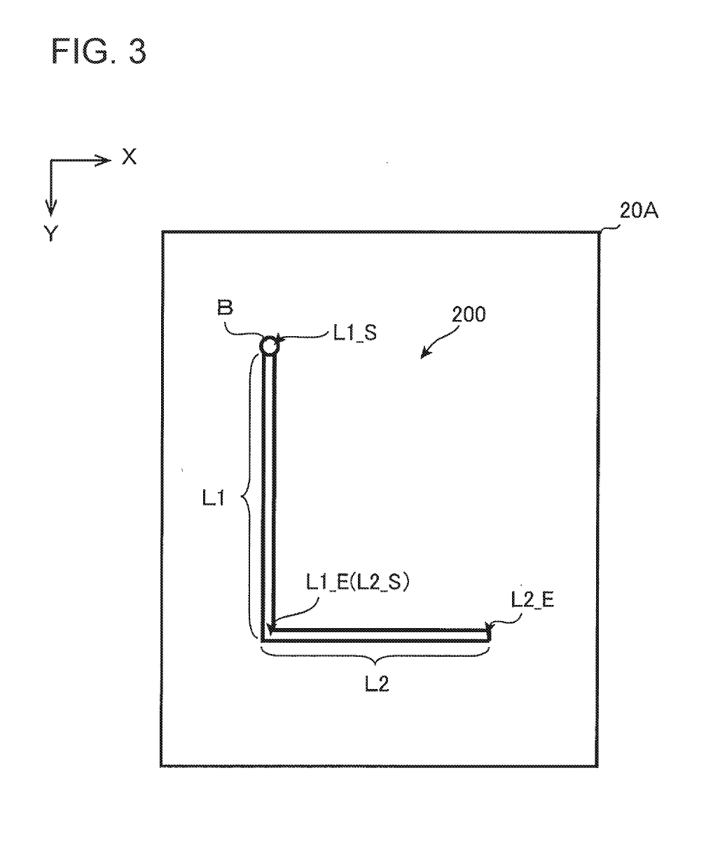

The touch panel 10 is a capacitive type touch panel, for example. The touch panel 10 includes a group of driver electrodes (not shown) and a group of sensor electrodes (not shown) arranged in a matrix and has a sensing region formed by the group of driver electrodes and the group of sensor electrodes. The touch panel 10 is provided on the display panel 20 such that the display region 20A (see FIG. 3) of the display panel 20 described later and the sensing region overlap. The touch panel control unit 11 described later controls the touch panel 10 to scan the group of driver electrodes sequentially and output signals that represent capacitance from the group of sensor electrodes.

The touch panel control unit 11 sequentially outputs scan signals to the driving electrodes of the touch panel 10. When the signal value outputted by the sensor electrode is greater than or equal to a threshold value, the touch panel control unit detects as an input location the coordinates that correspond to the intersection of the driving electrode and the sensor electrode where the signal value was obtained and outputs the coordinates that represent the detected input location to the control unit 40. The coordinates of the input location detected by the touch panel control unit 11 are coordinates within a coordinate range (default values) that was set by default in accordance with the display region 20A.

The display panel 20 is a liquid crystal panel, in which a liquid crystal layer (not shown) is sandwiched between an active matrix substrate, which transmits light, and an opposite substrate (both not shown). On the active matrix substrate, a plurality of gate lines (not shown) and a plurality of source lines (not shown) that intersect with the gate lines are formed. The substrate includes a display region 20A (see FIG. 3) that is made of pixels defined by the gate lines and the source lines. A pixel electrode (not shown) connected to a gate line and a source line is formed in each of the pixels on the active matrix substrate, and a common electrode (not shown) is formed on the opposite substrate.

The display panel control unit 21 includes a gate driver (not shown) that scans the gate lines (not shown) of the display panel 20, and a source driver (not shown) that provides data signals to the source lines (not shown) of the display panel 20. The display panel control unit 21 outputs a prescribed voltage signal to the common electrode and outputs control signals including timing signals such as clock signals to the gate driver and the source driver. Because of this configuration, the gate lines are sequentially scanned by the gate driver, the data signals are provided to the source lines by the source driver, and an image that corresponds to the respective data signals is displayed in the respective pixels.

The backlight 30 is provided on the back surface of the display panel 20. The backlight 30 includes a plurality of LEDs (light-emitting diodes) and lights the plurality of LEDs based on the luminance instructed by the backlight control unit 31 described later. The backlight control unit 31 outputs a luminance signal to the backlight 30 based on the luminance instructed by the control unit 40.

The control unit 40 includes a CPU (central processing unit), a memory (ROM (read only memory)), and RAM (random access memory), which are not shown. FIG. 2 is a function block diagram of the control unit 40. By having the CPU execute a control program stored in the ROM, the control unit 40 implements the respective functions of a lock setting unit 401, an unlock unit 402, a coordinate setting unit 403, and a correction unit 404 shown in FIG. 2. Each of these units will be described below.

The lock setting unit 401 allows the display panel control unit 21 to display a lock screen, which restricts the operation of the touch panel 10, at the timing when the display device 1 is turned ON and activates the lock function. Setting the lock function makes the display device 1 not register any operations other than the prescribed unlocking operation (described later) performed on the lock screen and disables the use of applications in the display device 1.

FIG. 3 is a diagram showing an example of a lock screen displayed on the display region 20A of the display panel 20. An unlock image 200 for deactivating the lock function is displayed on the lock screen. In this example, the unlock image 200 includes an unlocking button B, a line segment image (first line segment image) L1, which is parallel to the Y axis of the display region 20A, and a line segment image (second line segment image) L2, which is parallel to the X axis of the display region 20A. In this example, the prescribed unlocking operation refers to the following: touching the unlocking button B and tracing a path starting from the unlocking button B, or in other words the upper end L1_S of the line segment image L1, through the lower end L1_E, and from the left end L2_S (L1_E) to the right end L2_E.

The unlock unit 402 stops displaying the lock screen when the touch operation on the touch panel 10 performed while the lock screen was being displayed is the prescribed unlocking operation (specific touch operation) and instructs the display panel control unit 21 to display the application operation screen that is activated when the power is turned ON. The unlock unit 402 determines a touch operation as the prescribed unlocking operation when the coordinates of the input locations of the touch operation performed while the lock screen is being displayed fall within a prescribed range, which is based on the display location of the unlock image 200. Thus, operations other than the prescribed unlocking operation do not deactivate the lock function, and the lock screen will continue to be displayed by the lock setting unit 401.

When the unlock unit 402 deactivates the lock function, the coordinate setting unit 403 adjusts the coordinate range of the sensing region default values based on the plurality of input locations obtained from the unlocking operation (referred to as unlocking input locations below) and the display location of the unlock image 200. Specifically, in the example given in FIG. 3, the coordinate setting unit 403 resets the coordinate range spanned by the sensing region using the locations of the unlocking button B (the upper end L1_S of the line segment image L1), the lower end L1_E of the line segment image L1 (the left end L2_S of the line segment image L2), the right end L2_E of the line segment image L2 in the coordinate plane of the display region 20A, and the unlocking input locations that include the unlocking button B, the lower end L1_E of the line segment image L1, and the right end L2_E of the line segment image L2. The coordinate setting unit 403 stores the base coordinates that represent the set coordinate range as coordinate data in the storage unit 50 (described later).

After deactivating the lock function, the correction unit 404 corrects the input locations outputted from the touch panel control unit 11 based on the base coordinates set by the coordinate setting unit 403.

A specific description about the setting of the base coordinates that represent the coordinate range of the sensing region by the coordinate setting unit 403 and the correction of input location by the correction unit 404 will be given in an example of operation described later.

The description of the remaining units will be continued while referring back to FIG. 1. The storage unit 50 is a non-volatile storage medium such as flash memory. Besides various types of data such as programs for applications executed by the display device 1, application data used by the applications, and user data, the storage unit 50 stores the data about the base coordinates set by the coordinate setting unit 403.

The operation button unit 60 includes the power button of the display unit 1 and operation buttons such as menu buttons. The operation unit 60 outputs an operation signal that represents the content of the user operation to the control unit 40.

(Operation Example)

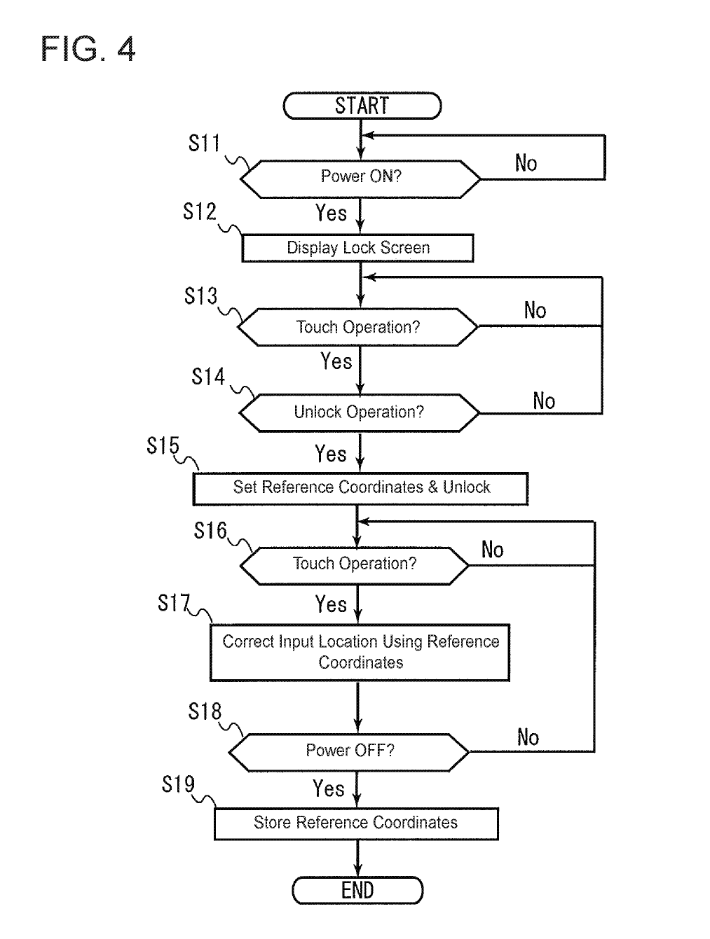

Below, the display device 1 according to the present embodiment will be described. FIG. 4 is a chart showing a flow of operation in the display device 1.

The control unit 40 remains on standby until a control signal that turns the power button ON is received from the operation button unit 60 (step S11: No). When the control signal that turns the power button ON is outputted from the operation button unit 60 (step S11: Yes), the display panel control unit 21 makes the display panel 20 display the lock screen shown in FIG. 3 as an example (step S12).

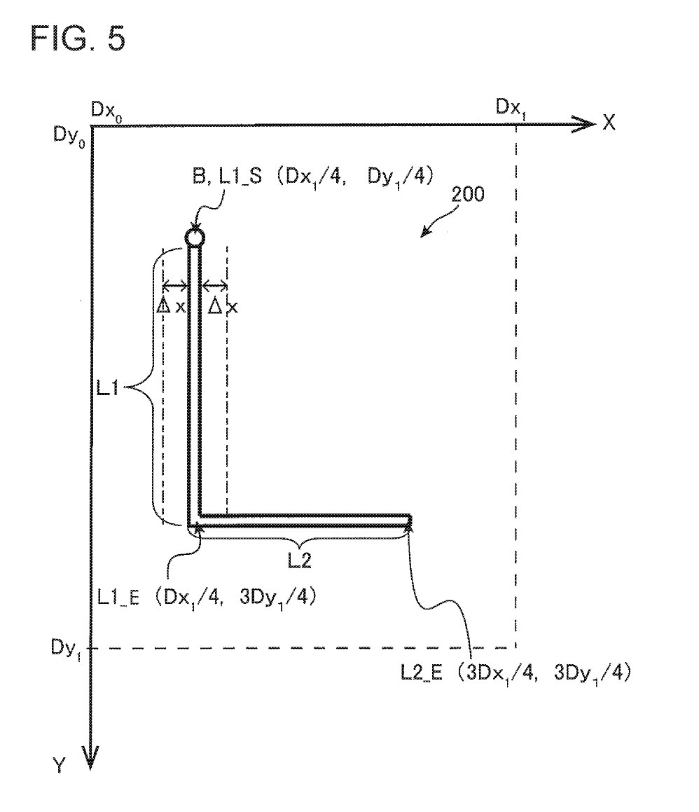

Here, the display location of the unlock image according to the present embodiment will be described. FIG. 5 is a diagram showing an example of an unlock image in the coordinate plane of the display region 20A. In this example, the coordinate range of the display region 20A is from (Dx₀, Dy₀) to (Dx₁, Dy₁).

As shown in FIG. 5, the display location of the unlocking button B of the unlock image 200 is (Dx₁/4, Dy₁/4). The display location of the upper end L1_S of the line segment image L1 is the same as the display location of the unlocking button B, and the display location of the lower end L1_E of the line segment image L1 is (Dx₁/4, 3Dy₁/4). Also, the display location of the left end L2_S of the line segment image L2 is the same as the display location of the lower end L1_E of the line segment image L1, and the display location of the right end L2_E of the line segment image L2 is (3Dx₁/4, 3Dy₁/4).

The description of the flow of operation will be continued while referring back to FIG. 4. After the lock screen is displayed, once the control unit 40 obtains the coordinates that represent the input locations of the touch operation performed on the touch panel 10 from the touch panel control unit 11 (step S13: Yes), the control unit determines whether or not the touch operation is the unlocking operation (step S14). In other words, the control unit 40 determines whether or not the coordinates of the input locations obtained by the touch operation fall within the prescribed range, which is based on the display location of the unlock image. In the present embodiment, the prescribed range is the range indicated by Ax in the X axis direction, which is perpendicular to the line segment image L1, as shown by the dashed-dotted line in FIG. 5.

When the coordinates of the input locations obtained in step S13 fall within the prescribed range (step S14: Yes), the control unit 40 determines that the unlocking operation was performed and sets the coordinate range of the touch panel 10 and deactivates the lock function (step S15).

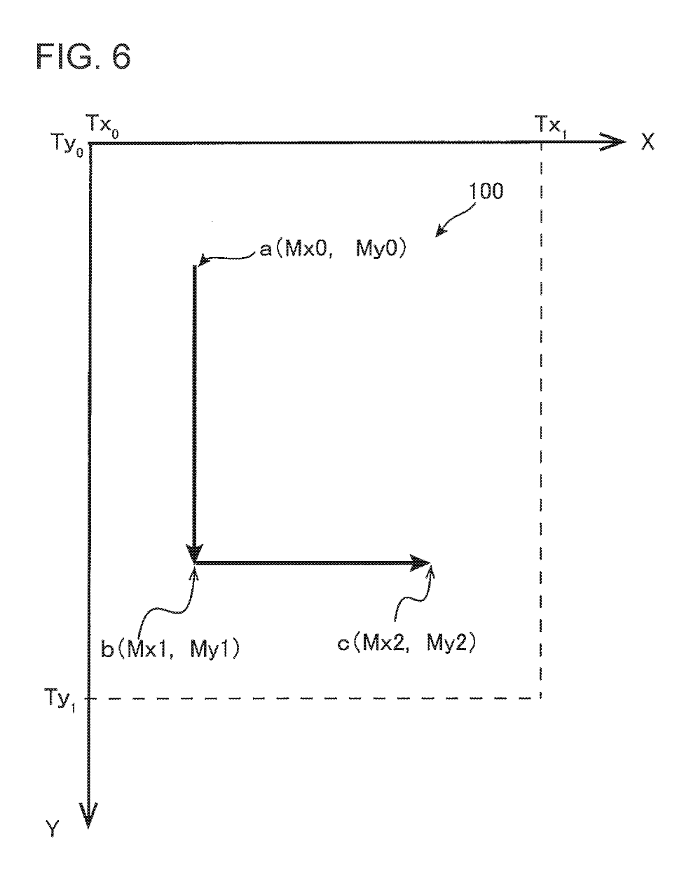

Below, the process for setting the coordinate range of the touch panel 10 will be described specifically using the example in FIG. 5. FIG. 6 is a diagram showing the coordinate plane of the sensing region. In FIG. 6, the coordinate range spanned by the touch panel 10 is from (Tx₀, Ty₀) to (Tx₁, Ty₁). Also, in FIG. 6, a curve 100 that connects a(Mx0, My0), b(Mx1, My1), and c(Mx2, My2) represents the path of the coordinates obtained from the touch panel control unit 40 by the unlocking operation.

In FIG. 6, the control unit 40 specifies the starting point a, which is obtained first from the touch panel control unit 11 in step S13 as the input location with respect to the unlocking button B, and the end point c, which is obtained last, as the input location with respect to the right end L2_E of the line segment image L2. Also, the control unit 40 specifies the beginning point b of a segment of the obtained input locations for which the Y coordinate value is approximately constant as the input location with respect to the lower end L1_E of the line segment image L1.

The control unit 40 sets the base coordinates (Tx₀, Ty₀) and (Tx₁, Ty₁), which represent the coordinate range of the touch panel, in accordance with each of the coordinates of the specific input locations a, b, c and the display locations of the unlocking button B, the lower end L1_E of the line segment image L1, and the right end L2_E of the line segment image L2.

As shown in FIG. 5, the distance between the line segment image L1 and the Y axis is Dx₁/4, and the length of the line segment image L2 is Dx₁/2. Thus, the reference coordinate Tx₀ can be calculated by equation (1) below. In equation (1) below, Mxl may be replaced with Mx0.

Tx₀=Mx1−(Mx2−Mx1)/2 (1)

As shown in FIG. 5, the distance between the unlocking button B and the X axis is Dy₁/4, and the length of the line segment image L1 is Dy₁/2. Thus, the reference coordinate Ty₀ can be calculated by the equation (2) below.

Ty₀=My0−(My1−My0)/2 (2)

As shown in FIG. 5, the distance between the right end L2_E of the line segment image L2 and the Y axis is 3Dx₁/4, or in other words the distance from the right end L2_E of the line segment image L2 to the straight line satisfying the relation X=Dx₁ is Dx₁/4, and the length of the line segment image L2 is Dx₁/2. Thus, the reference coordinate Tx₁ can be calculated by equation (3) below.

Tx₁=Mx2+(Mx2−Mx1)/2 (3)

As shown in FIG. 5, the distance between the lower end L1_E of the line segment image L1 and the X axis is 3Dy₁/4, or in other words the distance from the lower end L1_E of the line segment image L1 to the straight line satisfying the relation Y=Dy₁ is Dy₁/4, and the length of the line segment image L1 is Dy₁/2. Thus, the reference coordinate Ty₁ can be calculated by equation (4) below. In equation (4) below, Myl may be replaced with My2.

Ty₁=My1+(My1−My0)/2 (4)

The control unit 40 stores in the RAM the base coordinates (Tx₀, Ty₀) and (Tx₁, Ty₁), which represent the coordinate range spanned by the touch panel 10, instructs the display panel 20, via the display panel control unit 21, to display a display screen showing applications that need to be executed when the power is turned ON, and deactivates the lock function.

The description of the flow of operation will be continued while referring back to FIG. 4. When the control unit 40 obtains the coordinates that represent the input location of a touch operation performed on the touch panel 10 (step S16: Yes), the control unit reads out from the RAM the base coordinates set in step S15 and corrects the input location using the base coordinates (step S17). Specifically, the control unit 40 calculates the corrected values (X, Y) by substituting the base coordinates (Tx₀, Ty₀) and (Tx₁, Ty₁) and the input location coordinates (Px, Py) into equations (5) and (6).

X={(Px−Tx₀)/(Tx₁−Tx₀)}×(Dx₁−Dx₀) (5)

Y={(Py−Ty₀)/(Ty₁−Ty₀)}×(Dy₁−Dy₀) (6)

After the process in step S15, the control unit 40 remains on standby until a touch operation is performed in step S16 (step S16: No). In step S18, the control unit 40 repeats the processes in steps S16 and S17 until a control signal that turns OFF the power button of the display device 1 is outputted from the operation button unit 60 (step S18: No). Once the control signal that turns OFF the power button of the display device 1 is outputted from the operation button unit 60 (step S18: Yes), the control unit 40 stores the data (coordinate data) about the base coordinates set in step S15 in the storage unit 50 (step S19).

Either until the coordinates that represent the input locations of a touch operation in step S13 are received from the touch panel control unit 11 (step S13: No) or when it is determined in step S14 that the touch operation in step S13 is not the unlocking operation (step S14: No), the control unit 40 continues to display the lock screen and repeats the processes in step S13 and thereafter.

In the embodiment described above, when the power button of the display device 1 is turned ON, the display device 1 displays the lock screen and makes any touch operations other than the unlocking operation invalid. Then, the display device 1 sets the base coordinates that represent the coordinate range spanned by the touch panel 10 in accordance with the plurality of input locations obtained from the unlocking operation and the display location of the unlock image. After deactivating the lock function, using equations (5) and (6), the display device 1 calculates the coordinates that reflect the input locations in the coordinate range based on the reference coordinate in the coordinate plane of the display region 20A as the corrected values. Thus, without separately providing an adjustment screen for adjusting the coordinate range of the touch panel 10, the display device can reset the coordinate range spanned by the touch panel 10 in accordance with the unlocking operation. Based on that coordinate range, the display device can correct input location after unlocking. Thus, the users of the display device 1 can adjust the coordinate range of the touch panel 10 merely by performing the unlocking operation.

An embodiment of the present invention has been described above, but the embodiment described above is merely an example of an implementation of the present invention. Thus, the present invention is not limited to the embodiment described above, and can be implemented by appropriately modifying the embodiment described above without departing from the spirit of the present invention. Next, modification examples of the present invention will be described.

### MODIFICATION EXAMPLES

(1) The embodiment above described an example in which input location on the touch panel 10 is corrected using the base coordinates of the touch panel 10, which are set every time the unlocking operation is performed. If the gap between the base coordinates set by the unlocking operation and the base coordinates set in advance (reference base coordinates) is less than a threshold value, the correction may be performed using the base coordinates. However, if the gap is greater than or equal to the threshold value, the correction may be performed using the reference base coordinates instead of the base coordinates. Also, when the gap between the base coordinates and the reference base coordinates is greater than or equal to the threshold value, upper limit coordinates, which are coordinates between the base coordinates and the reference base coordinates, and for which the distance to the reference base coordinates is below the threshold value, may be used for the correction. The reference base coordinates may be the base coordinates that represent the coordinate range of the default values of the touch panel 10 or the base coordinates set by the previous unlocking operation and stored in the storage unit 50, for example.

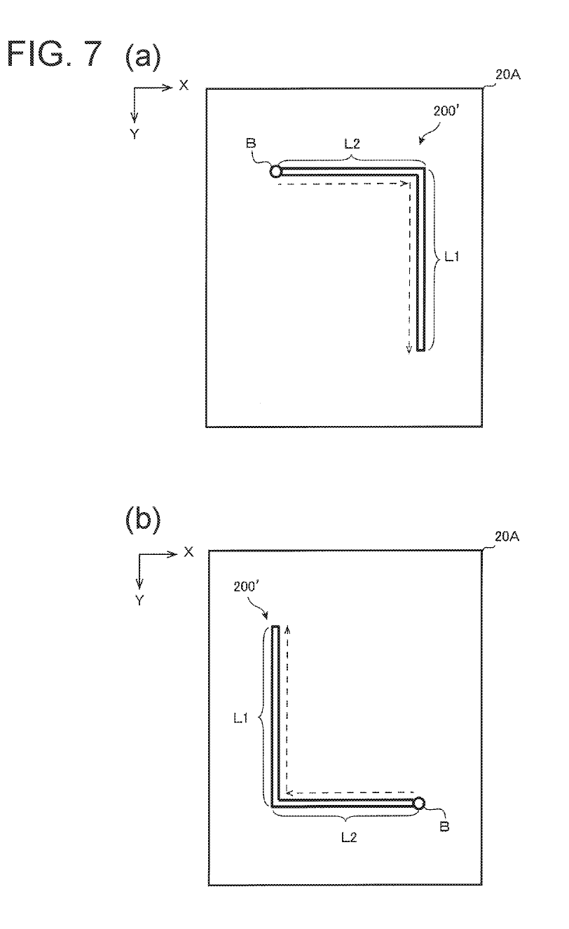

(2) In the embodiment described above, the unlock image 200 is not limited to the example shown in FIG. 3. As long as an image has a line segment image that is parallel to the X axis and a line segment image that is parallel to the Y axis, the image may be used. Examples of images used for unlocking 200′, which are modification examples of the present embodiment, are shown in FIGS. 7(a) and 7(b). In the example shown in FIG. 7(a), the unlock image 200′ is arranged such that the left end of the line segment image L2 and the unlocking button B are at the same location and the right end of the line segment image L2 and the upper end of the line segment image L1 are at the same location. In this case, as shown by the dotted lines in FIG. 7(a), an operation that traces the unlocking button B, the line segment image L2, and the line segment image L1 in that order may be defined as the unlocking operation. Similarly, as shown in FIG. 7(b), the unlocking button B and the right end of the line segment image L2 may be displayed at the same location, for example. In this case, as shown by the dotted lines in FIG. 7(b), an operation that traces the unlocking button B, the line segment image L2, and the line segment image L1 in that order may be defined as the unlocking operation.

(3) The embodiment above described an example in which the lock function was set when the power button of the display device 1 was turned ON. However, when a state in which no touch operations are performed on the touch panel 10 continues for longer than a given length of time, the lock function may be set after that given length of time has elapsed. In this case, in a manner similar to the embodiment described above, the control unit 40 may set the base coordinates of the touch panel 10 by the unlocking operation every time the lock function is deactivated. The setting of the lock function may be performed either when the power button is turned ON or when the state in which no touch operations are performed has continued for the given length of time, or the setting of the lock function may be performed at each of these instances.

(4) In the embodiment and the modification examples described above, the control unit 40 may display, on the lock screen, the unlock image at different locations in a random manner every time the lock function is set.

(5) In the embodiment and the modification examples described above, the control unit 40 may display the unlock image in a different location in accordance with the dominant hand of the user. In this case, the control unit 40 obtains from the outside thereof the user information that represents the dominant hand of the user and stores the user information in the storage unit 50. When setting the lock function, if the user information is stored in the storage unit 50, the control unit 40 displays the unlock image in a location based on the user information. When the user information indicates that the user is right-handed, the control unit 40 may display the unlock image off to the left of the center of the lock screen, and when the user information indicates that the user is left-handed, the control unit may display the imaged used for unlocking off to the right of the center of the lock screen, for example. In particular, when using a touch pen to perform an input, fixing the dominant hand to the display surface makes the input posture of the user more stable and the input operation easier. Thus, shifting the unlock image on the lock screen toward the side opposite to the dominant hand makes the input operation easier.

(6) The embodiment above described an example in which deactivating the lock function required that the input locations of the unlocking operation fall within a prescribed range that takes the line segment image L1 as the point of reference. However, the line segment image L2 may be taken as the point of reference, and the condition for deactivation may require that the input location of the unlocking operation fall within a prescribed range in a direction that is perpendicular to the line segment image L2. Alternatively, the requirement may be that each of these two conditions be satisfied.

### INDUSTRIAL APPLICABILITY

The present invention can be applied to the industry of display devices equipped with touch panels.

1. A display device, comprising:
a display unit;
a touch panel attached to the display unit; and
a control unit configured to, at a prescribed timing, cause a prescribed image to be displayed on a display region of the display unit and activate a lock function, said lock function making invalid any touch operation on the touch panel other than a specific touch operation with respect to the prescribed image,
wherein, when a touch operation is performed on the touch panel while the prescribed image is displayed, the control unit deactivates the lock function when the control unit determines that the touch operation is the specific touch operation based upon a plurality of obtained input locations on the touch panel due to the touch operation relative to a display location of the prescribed image on the display region,
wherein, when the control unit determines that the specific touch operation is performed, the control unit sets coordinate data representing a coordinate range of the touch panel based upon the plurality of input locations and the display location of the prescribed image, and
wherein, the control unit corrects an input location of a touch operation that is performed after the control unit deactivates the lock function on the touch panel in accordance with the coordinate data set by the control unit.

2. The display device according to claim 1,
wherein the display region has a rectangular shape,
wherein the prescribed image includes: a first line segment image that is parallel to one side of the rectangular shape; and a second line segment image that is parallel to a side of the rectangular shape perpendicular to said one side of the rectangular shape,
wherein the specific touch operation is an operation that traces the first line segment image and the second line segment image,
wherein the control unit determines that the specific touch operation has been performed and deactivates the lock function when the plurality of input locations on the touch panel with respect to at least one of the first line segment image and the second line segment image is within a prescribed range that is perpendicular to the respective line segment images, and
wherein, when the lock function is deactivated, the control unit sets the coordinate range.

3. The display device according to claim 1, wherein, when a distance between base coordinates that define said coordinate range of the touch panel, set by the control unit based upon the plurality of input locations and the display location of the prescribed image, and reference base coordinates that define a coordinate range of the touch panel that is set previously either at a time of initial assembly or a time when the specific touch operation was performed previously, is greater than or equal to a threshold value, the control unit sets the reference base coordinates as the coordinate range.

4. The display device according to claim 1, wherein, when a distance between base coordinates that define said coordinate range of the touch panel, set by the control unit based upon the plurality of input locations and the display location of the prescribed image, and reference base coordinates that define a coordinate range of the touch panel that is set previously either at a time of initial assembly or a time when the specific touch operation was performed previously, is greater than or equal to a threshold value, the control unit sets, as the coordinate range, upper limit coordinates, which are between the base coordinates and the reference base coordinates and for which a distance between the upper limit coordinates and the reference base coordinate is less than the threshold value.

5. The display device according to claim 1, wherein the prescribed timing is at least one of a timing at which the display device is turned ON and a timing at which a state in which no touch operation is performed has continued for a certain length of time after the lock function has been deactivated.
